(19) United States
(12) Patent Application Publication
(10) Pub. No.: US 2026/0153900 A1
(43) Pub. Date: Jun. 4, 2026

(54) DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Yue LEI, Beijing (CN); Hong ZHU, Beijing (CN); Xiaolin LIU, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 19/122,761

(22) PCT Filed: Oct. 12, 2023
(86) PCT No.: PCT/CN2023/124340

§ 371 Date: Apr. 21, 2025

(30) Foreign Application Priority Data
Oct. 24, 2022 (CN) 202211303921.6

(51) Int. Cl. G06F 1/16

(52) U.S. Cl. CPC G06F 1/1652; G06F 1/1616; G06F 1/1624; G06F 1/1681

(57) ABSTRACT

A display device includes: a display housing, including a first main housing and a second main housing, where a width of the first main housing is greater than a width of the second main housing; a folding mechanism, located between the first main housing and the second main housing, and respectively connected with an edge of the first main housing along a length direction and an edge of the second main housing along the length direction, where the first main housing and the second main housing are switchable between folding and unfolding; and a flexible display screen, respectively connected with the first main housing and the second main housing, and provided with a binding area, where the binding area is located at one side of the first main housing in the length direction.

### CROSS REFERENCE TO RELATED APPLICATION

The present application claims the priority of the Chinese Patent Application No. 2022113039216, titled “DISPLAY DEVICE”, filed on Oct. 24, 2022, which is incorporated herein by reference in its entirety.

### TECHNICAL FIELD

The present disclosure relates to a field of display technologies, in particular to a display device.

### BACKGROUND

In the field of display technologies, a flexible display screen has characteristics of slim, lightweight and excellent bending flexibility. In the related art, based on the characteristics of flexible display screen, structural forms of the display devices are expanded, such as folding form, folding and sliding roll form, and the like. However, for the display devices in folding form and folding and sliding roll form, a binding area of the flexible display screen will inevitably be narrowed, thereby improving the wiring difficulty of the binding area.

It should be noted that the above information disclosed in the background is only for enhancing understanding of the background of the present disclosure, so it may include information that does not form the prior art that is known to the ordinary skilled in the art.

### SUMMARY

The purpose of the present disclosure is to provide a display device, which can increase a width of a binding area of the display device, thereby reducing the wiring difficulty.

According to an aspect of the present disclosure, a display device is provided and includes:
a display housing, which includes a first main housing and a second main housing, where a width of the first main housing is greater than a width of the second main housing;
a folding mechanism, which is located between the first main housing and the second main housing and is respectively connected with an edge of the first main housing along a length direction and an edge of the second main housing along the length direction, where the first main housing and the second main housing are switchable between folding and unfolding; and
a flexible display screen, which is respectively connected with the first main housing and the second main housing and is provided with a binding area, where the binding area is located at one side of the first main housing in the length direction.

According to any one of the display devices of the present disclosure, the first main housing includes a first main shell and a first sliding shell.

An edge of the first main shell along the length direction is connected with the folding mechanism, the first sliding shell is connected at one side of the first main shell away from the folding mechanism, and the first sliding shell is slidable relative to the first main shell along a direction perpendicular to the length direction.

The flexible display screen is slidably fixed on the first sliding shell, and the binding area is located at one side of the first main shell in the length direction.

According to any one of the display devices of the present disclosure, a shell wall of the first main shell is provided with a plurality of first comb teeth structures facing the first sliding shell, a shell wall of the first sliding shell is provided with a plurality of second comb teeth structures facing the first main shell, and the plurality of first comb teeth structures are meshed with the plurality of second comb teeth structures.

According to any one of the display devices of the present disclosure, the first comb tooth structure and the second comb tooth structure are both rectangular.

According to any one of the display devices of the present disclosure, the first sliding shell includes a first frame, a second frame, a side plate and a plurality of sliding rods.

The first frame and the second frame are oppositely arranged, the side plate is connected between the first frame and the second frame, opposite side walls of the first frame and the second frame are provided with slideways, ends of the plurality of sliding rods are slidably limited in the slideways on the first frame and the second frame, and the flexible display screen is fixed on the plurality of sliding rods.

According to any one of the display devices of the present disclosure, the first main housing further includes a first transmission mechanism including a driving motor and a transmission rack.

The driving motor is fixed on one of the first main shell and the first sliding shell, the transmission rack is fixed on the other of the first main shell and the first sliding shell, a length direction of the transmission rack is perpendicular to the length direction of the first main shell, and an output shaft of the driving motor is in transmission connection with the transmission rack.

According to any one of the display devices of the present disclosure, the first transmission mechanism includes a first transmission rack and a second transmission rack.

The driving motor is a double-shaft output motor, and two output shafts of the driving motor are respectively in transmission connection with the first transmission rack and the second transmission rack.

Alternatively, the first transmission mechanism includes a first driving motor and a second driving motor, the first driving motor is in transmission connection with the first transmission rack, and the second driving motor is in transmission connection with the second transmission rack.

According to any one of the display devices of the present disclosure, the first transmission mechanism includes a transmission rod, the driving motor is in transmission connection with the transmission rod, and the transmission rod is in transmission connection with the transmission rack.

According to any one of the display devices of the present disclosure, one of the first sliding shell and the first main shell is provided with a slide slot, and the transmission rack is fixed on the other of the first sliding shell and the first main shell and slidably limited in the slide slot.

According to any one of the display devices of the present disclosure, the second main housing includes a second main shell and a second sliding shell.

An edge of the second main shell along the length direction is connected with the folding mechanism, the second sliding shell is connected at one side of the second main shell away from the folding mechanism, and the second sliding shell is slidable relative to the second main shell along a direction perpendicular to the length direction.

According to any one of the display devices of the present disclosure, a maximum slide stroke of the first sliding shell is twice that of the second sliding shell.

According to any one of the display devices of the present disclosure, the width of the first main housing is twice that of the second main housing.

Some embodiments of the present disclosure at least have the following technical effects.

In some embodiments of the present disclosure, the width of the first main housing is greater than the width of the second main housing, thereby realizing asymmetric folding of the display device. In this way, the binding area of the flexible display screen is arranged at one side of the first main housing in the length direction, so that a maximum setting width of the binding area is more than half the width of the display device. Compared with the symmetrically folding display device in the related art (the maximum setting width of the binding area is only half the width of the display device), the maximum setting width of the binding area can substantially be increased according to the display device provided by some embodiments of the present disclosure, thereby reducing the wiring difficulty for the binding area with the maximum setting width. In addition, when the display device is in a folding state, the second main housing cannot completely shield the first main housing, and normal display can be achieved by the flexible display screen in an uncovered area of the first main housing, thereby increasing a screen ratio mode of the display device.

It is to be understood that both the foregoing general description and the following detailed description are exemplary and explanatory only and are not restrictive of the present disclosure.

### BRIEF DESCRIPTION OF DRAWINGS

The drawings, which are incorporated in and constitute a part of this description, illustrate examples consistent with the present disclosure and together with the description, explain the principles of the present disclosure. It can be understood that the drawings in the following description are only some embodiments of the present disclosure. For ordinary skilled in this art, other drawings can be obtained according to these drawings without creative work.

FIG. 1 illustrates a structural schematic diagram of the display device in the folding state provided by an embodiment of the present disclosure.

FIG. 2 illustrates a structural schematic diagram of the display device in the unfolding state provided by an embodiment of the present disclosure.

FIG. 3 illustrates a structural schematic diagram of the flexible display screen provided by an embodiment of the present disclosure.

FIG. 4 illustrates a structural schematic diagram of the display device in an unfolding and sliding roll state provided by an embodiment of the present disclosure.

FIG. 5 illustrates a structural schematic diagram of another flexible display screen provided by an embodiment of the present disclosure.

FIG. 6 illustrates an exploded structural schematic diagram of a display housing provided by an embodiment of the present disclosure.

Reference numbers are as follows:
1. Display housing; 2. Folding mechanism; 3. Flexible display screen;
11. First main housing; 12. Second main housing;
111. First main shell; 112. First sliding shell; 113. First transmission mechanism;
1111. First comb tooth structure;
1121. First frame; 1122. Second frame; 1123. Side plate; 1124. Sliding rod; 1125. Second comb tooth structure;
1131. Drive motor; 1132. Transmission rack; 1133. Transmission rod; 121. Second main shell; 122. Second sliding shell; 123. Second transmission mechanism;
31. Binding area; 32. First display area; 33. Second display area; 34. Folding zone; 35. First sliding rolling zone; 36. Second sliding rolling zone.

### DETAILED DESCRIPTION

Exemplary embodiments will now be described more fully by reference to the accompanying drawings. However, the exemplary embodiments can be implemented in various forms and should not be understood as being limited to the examples set forth herein; rather, the embodiments are provided so that the present disclosure will be thorough and complete, and the conception of exemplary embodiments will be fully conveyed to those skilled in the art. The same reference numbers in the drawings denote the same or similar structures and thus their detailed descriptions will be omitted. In addition, the drawings are only schematic illustrations of the present disclosure and are not necessarily drawn to scale.

Although relative terms such as “up/on/above” and “down/under/below” are used in this description to describe the relative relationship of one illustrated component to another, these terms are used in this description only for convenience, for example, according to the directions of the examples described in the drawings. It can be understood that if the illustrated device is turned upside down, the component described as “up/on/above” will become the component described as “down/under/below”. When a structure is “on” another structure, it may mean that the structure is integrally formed on another structure, or that the structure is “directly” arranged on another structure, or that the structure is “indirectly” arranged on another structure through other structures.

The terms “one”, “a”, “the”, “said” and “at least one” are used to indicate the existence of one or more elements/components or the like; the terms “comprise/include” and “have” are used to indicate an open meaning of including and means that there may be additional elements/components/etc. in addition to the listed elements/components/etc. The terms “first”, “second” and “third” are only used as marks, not to limit the number of their subjects.

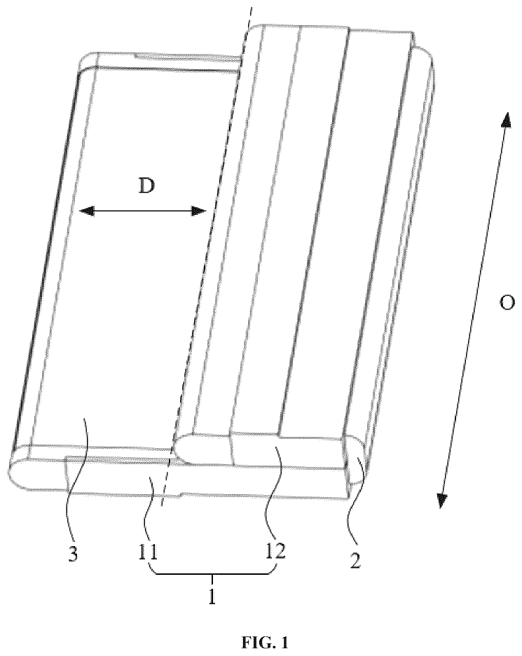

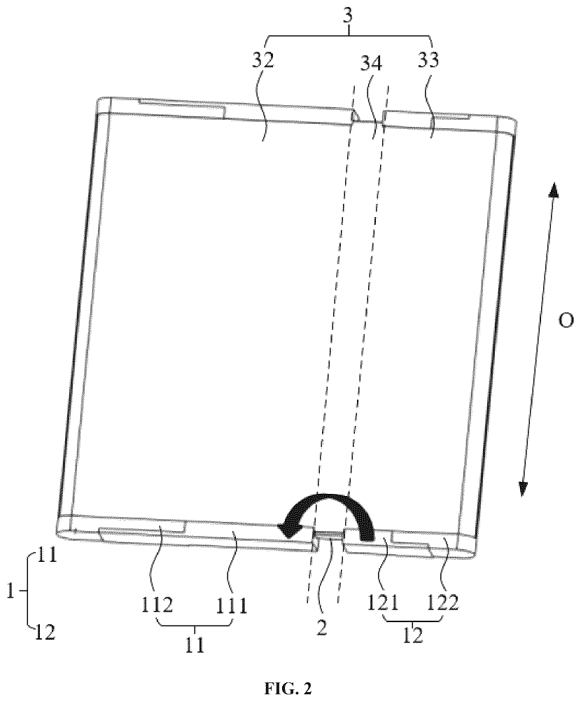

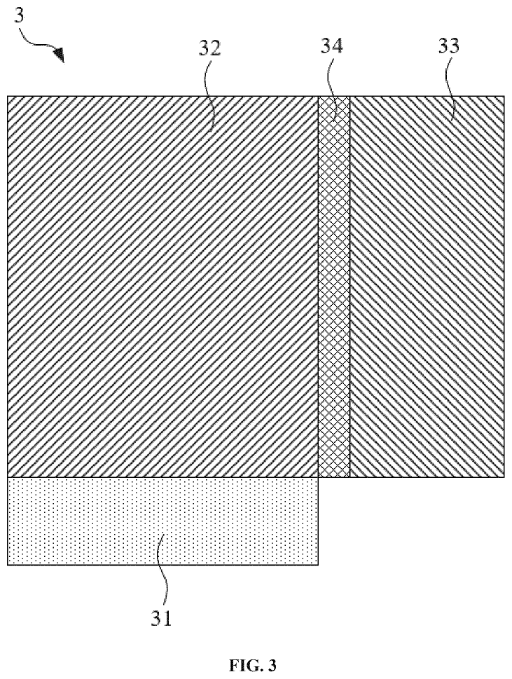

FIG. 1 illustrates the structural schematic diagram of the display device in the folding state provided by an embodiment of the present disclosure, FIG. 2 illustrates the structural schematic diagram of the display device in the unfolding state provided by an embodiment of the present disclosure, FIG. 3 illustrates a structural schematic diagram of the flexible display screen provided by an embodiment of the present disclosure. As shown in FIG. 1 or FIG. 2 and FIG. 3, the display device includes the display housing 1, the folding mechanism 2 and the flexible display screen 3. The display housing 1 includes the first main housing 11 and the second main housing 12, and the width of the first main housing 11 is greater than that of the second main housing 12. The folding mechanism 2 is located between the first main housing 11 and the second main housing 12, and is respectively connected with the edge of the first main housing 11 along the length direction and the edge of the second main housing 12 along the length direction. The first main housing 11 and the second main housing 12 are switchable between folding and unfolding. The flexible display screen 3 is respectively connected with the first main housing 11 and the second main housing 12 and is provided with the binding area 31. The binding area 31 is located at one side of the first main housing 11 in the length direction.

In some embodiments of the present disclosure, the width of the first main housing 11 is greater than the width of the second main housing 12, thereby realizing asymmetric folding of the display device. In this way, the binding area 31 of the flexible display screen 3 is arranged at one side of the first main housing 11 in the length direction, so that the maximum setting width of the binding area 31 is more than half the width of the display device. Compared with the symmetrically folding display device in the related art (the maximum setting width of the binding area 31 is only half the width of the display device), the maximum setting width of the binding area 31 can substantially be increased according to the display device provided by some embodiments of the present disclosure, thereby reducing the wiring difficulty for the binding area 31 with the maximum setting width.

The width of the first main housing 11 and the width of the second main housing 12 refer to the dimensions in the direction perpendicular to the length direction, and the length direction related to the present disclosure is the length direction of the display device, and it is the direction O shown in FIG. 1 or FIG. 2. After the first main housing 11 and the second main housing 12 are connected by the folding mechanism 2, they are switchable between folding and unfolding, so that the display device is provide with the folding state as shown in FIG. 1 or the unfolding state as shown in FIG. 2. The related art can be referred to for the specific structure of the folding mechanism 2, as long as the surfaces of the first main housing 11 and the second main housing 12 on the same side are coplanar when the display device is in the unfolding state, which is not limited by the embodiments of the present disclosure. Illustratively, the folding structure is a folding hinge.

As shown in FIG. 3, the flexible display screen 3 is provided with the first display area 32, the second display area 33, and the folding zone 34 located between the first display area 32 and the second display area 33. An edge of the first display area 32 is limited on the first main housing 11, so that an orthographic projection of the first display area 32 is located on the first main housing 11. An edge of the second display area 33 is limited on the second main housing 12, so that an orthographic projection of the second display area 33 is located on the second main housing 12. The flexible display screen 3 includes the binding zone 31 connected with the first display area 32. When the display device is in the folding state, the first display area 32 and the second display area 33 of the flexible display screen 3 are in a stacking state facing each other. When the display device is in the unfolding state, the first display area 32 and the second display area 33 of the flexible display screen 3 are in a coplanar form.

In the case that the display device is in the folding state, the first main housing 11 and the second main housing 12 may be folded oppositely. That is, folding is implemented in such a way that the first display area 32 and the second display area 33 are opposite. At this time, the first display area 32 and the second display area 33 are located between the first main housing 11 and the second main housing 12. The first main housing 11 and the second main housing 12 may also be folded back-to-back. That is, folding is implemented in such a way that the first display area 32 and the second display area 33 are reversed. At this time, the first main housing 11 and the second main housing 12 are located between the first display area 32 and the second display area 33.

When the first main housing 11 and the second main housing 12 are folded oppositely, since the width of the second main housing 12 is smaller than that of the first main housing 11, the second main housing 12 cannot completely cover the first display area 32. Therefore, when the display device is in the folding state, as shown in FIG. 1, an image can be displayed through an area D on the first display area 32 that is not covered by the second main housing 12, thereby realizing a screen ratio of the display device, and further increasing the screen ratio modes of the display device.

For the first main housing 11 and the second main housing 12 included in the display housing 1. When the first main housing 11 and the second main housing 12 are folding oppositely, the greater the ratio of the width of the first main housing 11 to the width of the second main housing 12, the wider the binding area 31 and the wider the display area that the display device may display when it is in the folding state, but the narrower the width of the second main housing 12, thereby affecting the aesthetics of the display device.

Optionally, the ratio of the width of the first main housing 11 to the width of the second main housing 12 is 2, that is, the width of the first main housing 11 is twice that of the second main housing 12. In this way, the width of the second main housing 12 is ⅓ of the width of the display device, so as to ensure the aesthetics of the display device in the folding state. Moreover, the display device has the wider binding area 31 (⅔ of the width of the display device), so as to reduce the wiring difficulty of the binding area 31. In addition, the display device has the wider display area (⅓ of the width of the display device) when it is in the folding state, so as to ensure a display effect of the display device when it is in the folding state.

Alternatively, the ratio of the width of the first main housing 11 to the width of the second main housing 12 may also be other values, which is not limited by the embodiments of the present disclosure, as long as the display device has the wider binding area 31 and, when it is in the folding state, the aesthetics of the display device is ensured, and the display device has the wider display area.

In some embodiments of the present disclosure, the display device may only have the folding form, and alternatively, the display device may also have the sliding rolling form. In the case that the display device has both the folding form and the sliding rolling form, the display device can not only realize the display of multiple screen ratios in the folding form, but also realize the display of at least one screen ratio in the sliding rolling form, thereby improving the display effect of the display device.

The structure of the display device with the folding form may be specifically described with reference to the above-mentioned embodiments, and the structure of the display device with the sliding rolling form will be explained next.

For the display device with the sliding rolling form, the first main housing 11 may have the sliding rolling state and the retracting state, or the second main housing 12 may have the sliding rolling state and the retracting state, or both the first main housing 11 and the second main housing 12 may have the sliding rolling state and the retracting state.

In the case that the first main housing 11 and the second main housing 12 both have the sliding rolling state and the retracting state, the display in a screen ratio can be realized by sliding rolling the first main housing 11 alone, the display in a screen ratio can be realized by sliding rolling the second main housing 12 alone, and the display in a screen ratio can be realized by sliding rolling the first main housing 11 and the second main housing 12 simultaneously.

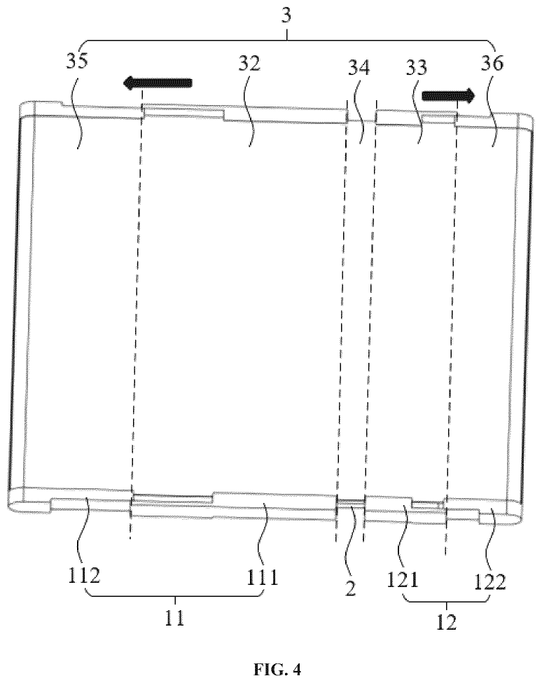

For example, when the first main housing 11 has the sliding rolling state and the retracting state, as shown in FIG. 2 or FIG. 4, the first main housing 11 includes the first main shell 111 and the first sliding shell 112. The edge of the first main shell 111 along the length direction is connected with the folding mechanism 2, the first sliding shell 112 is connected at one side of the first main shell 111 away from the folding mechanism 2, and the first sliding shell 112 is slidable relative to the first main shell 111 in the direction perpendicular to the length direction.

The first sliding shell 112 is slidable relative to the first main shell 111 along the direction perpendicular to the length direction. That is, the first sliding shell 112 may slide along a direction away from the first main shell 111, so that the first main shell 111 is in the sliding rolling state as shown in FIG. 4. Alternatively, the first sliding shell 112 may slide along a direction close to the first main shell 111, so that the first main shell 111 is in the retracting state as shown in FIG. 2. In this way, the first main housing 11 may be switched between the sliding rolling state and the retracting state by sliding the first sliding shell 112 relative to the first main shell 111.

In addition, in the case that the first main housing 11 includes the first main shell 111 and the first sliding shell 112, in order to ensure the normal display of the flexible display screen 3, the flexible display screen 3 is slidably fixed on the first sliding shell 112.

The flexible display screen 3 includes the binding area 31 located on one side of the first main shell 111 along the length direction. Moreover, the maximum design width of the binding area 31 is the width of the first main shell 111, so as to ensure the flexible display screen 3 to have the wider width, thereby reducing the wiring difficulty of the binding area 31.

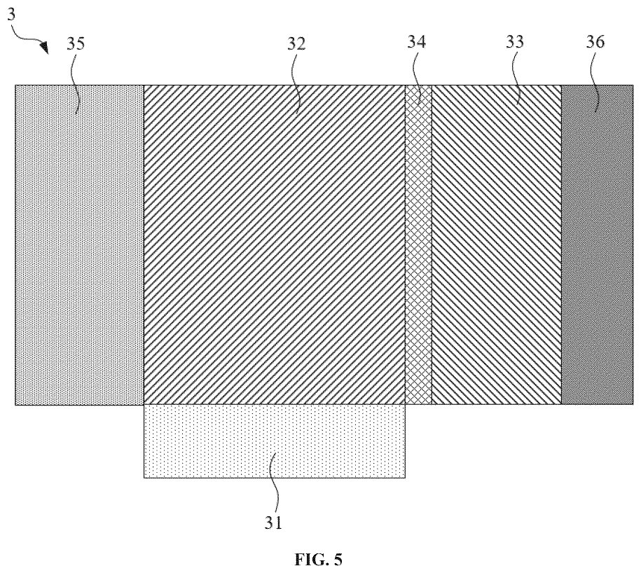

As shown in FIG. 5, the flexible display screen 3 includes not only the first display area 32, the second display area 33 and the folding zone 34, but also the first sliding rolling zone 35. The first display area 32 is limited on the first main shell 111, the second display area 33 is limited on the second main shell 121, and the first sliding rolling zone 35 is slidably fixed on the first sliding shell 112.

In this way, when the first sliding shell 112 moves along the direction away from the first main shell 111, the first sliding rolling zone 35 slides relative to the first sliding shell 112, so that the first sliding rolling zone 35 is in a flat form and is in the coplanar form with the first display area 32, so as to display images in the first sliding rolling zone 35, the first display area 32, the second display area 33 and the folding zone 34. When the first sliding shell 112 slides along the direction close to the first main shell 111, the first sliding rolling zone 35 slides relative to the first sliding shell 112, so that the first sliding rolling zone 35 is in a curled form, so as to display images in the first display area 32, the second display area 33 and the folding zone 34. In addition, when the first main housing 11 is switched between the sliding rolling state and the retracting state, the display device can also be switched between two different screen ratios, thereby improving the display effect of the display device.

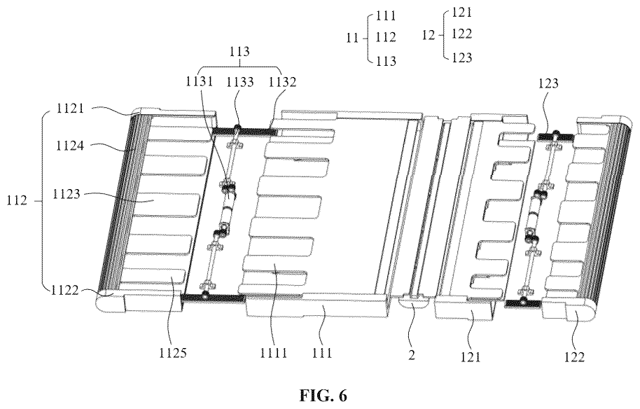

The related art can be referred to for the connection mode between the first sliding rolling zone 35 of the flexible display screen 3 and the first sliding shell 112, which is not limited by the embodiments of the present disclosure. For example, in some embodiments, as shown in FIG. 6, the first sliding shell 112 includes the first frame 1121, the second frame 1122, the side plate 1123 and a plurality of sliding rods 1124. The first frame 1121 and the second frame 1122 are oppositely arranged. The side plate 1123 is connected between the first frame 1121 and the second frame 1122. The opposite side walls of the first frame 1121 and the second frame 1122 are provided with slideways, ends of the sliding rods 1124 are slidably limited in the slideways on the first frame 1121 and the second frame 1122. The first sliding rolling zone 35 included in the flexible display screen 3 is fixed on the plurality of sliding rods 1124 (for example, by bonding).

In this way, when the first sliding shell 112 slides relative to the first main shell 111, the plurality of sliding rods 1124 slide in the slideways of the first frame 1121 and the second frame 1122, so as to realize the sliding of the first sliding rolling zone 35 of the flexible display screen 3, and ensure that the display device can be switched between two different screen ratios (displaying images through the first display area 32, the second display area 33 and the folding zone 34, or displaying images through the first display area 32, the second display area 33, the folding zone 34 and the first sliding rolling zone 35).

In some embodiments, as shown in FIG. 6, the shell wall of the first main shell 111 is provided with a plurality of first comb teeth structures 1111 facing the first sliding shell 112, and the shell wall of the first sliding shell 112 is provided with a plurality of second comb teeth structures 1125 facing the first main shell 111(for example, the side plate 1123 of the first sliding shell 112 is provided with the second comb tooth structure 1125 facing the first main shell 111), and the plurality of first comb teeth structures 1111 are meshed with the plurality of second comb teeth structures 1125.

The plurality of first comb tooth structures 1111 and the plurality of second comb tooth structures 1125 are distributed at intervals along the length direction, and the first comb tooth structures 1111 and the second comb tooth structures 1125 are alternately arranged, so as to facilitate the meshing of the first comb tooth structures 1111 and the second comb tooth structures 1125. When the first sliding shell 112 slides along the direction away from the first main shell 111, so that the first main housing 11 is in the sliding rolling state, the plurality of first comb tooth structures 1111 are meshed with at least the tooth tips of the plurality of second comb tooth structures 1125. When the first sliding shell 112 slides along the direction close to the first main shell 111, so that the first main housing 11 is in the retracting state, the plurality of first comb tooth structures 1111 are fully meshed with the plurality of second comb tooth structures 1125.

When the first sliding shell 112 slides along the direction away from the first main shell 111, a gap is to be formed between the first sliding shell 112 and the first main shell 111. Due to the arrangement of the first comb tooth structures 1111 and the second comb tooth structures 1125, when the first comb tooth structures 1111 are meshed with the second comb tooth structures 1125, a situation that the gap between the first sliding shell 112 and the first main shell 111 runs through the first main housing 11 along the length direction is avoided, thereby ensuring a supporting effect of the first main housing 11 on the flexible display screen 3 when the first main housing 11 of the display device is in the sliding rolling state. In addition, when the first main housing 11 is in the sliding rolling state, the plurality of first comb tooth structures 1111 are meshed with at least the tooth tips of the plurality of second comb tooth structures 1125. In this way, due to the limitation of two adjacent first comb tooth structures 1111 to a sandwiched second comb tooth structure 1125, and the limitation of two adjacent second comb tooth structures 1125 to a sandwiched first comb tooth structure 1111, the stability of the first sliding shell 112 sliding along the direction close to the first main shell 111 is ensured, and a situation that the first sliding shell 112 is inclined can be avoided.

Optionally, as shown in FIG. 6, the first comb tooth structure 1111 and the second comb tooth structure 1125 are both rectangular. Alternatively, in some embodiments of the present disclosure, the first comb tooth structure 1111 and the second comb tooth structure 1125 may all be triangular or trapezoidal, which is not limited in the embodiments of the present disclosure.

In the case that the first comb tooth structure 1111 and the second comb tooth structure 1125 are both rectangular, when the first sliding shell 112 slides relative to the first main shell 111, an edge of the first comb tooth structure 1111 along the sliding direction continuously contacts an edge of the second comb tooth structure 1125 along the sliding direction, so as to continuously limit the first sliding shell 112 and ensure the stability of the sliding of the first sliding shell 1125.

In some embodiments of the present disclosure, the sliding of the first sliding shell 112 relative to the first main shell 111 may be a manual sliding or an electrical sliding.

When the sliding of the first sliding shell 112 relative to the first main shell 111 is in the manual sliding mode, optionally, a first elastic limiting mechanism and a second elastic limiting mechanism are formed between the first sliding shell 112 and the first main shell 111. In this way, when the first sliding shell 112 slides relative to the first main shell 111, it can be limited to a first position or a second position, thus ensuring that the first sliding shell 112 is in the retracting state or the sliding rolling state relative to the first main shell 111.

When the sliding of the first sliding shell 112 relative to the first main shell 111 is in the electrical sliding mode, as shown in FIG. 6, the first main housing 11 further includes the first transmission mechanism 113, which includes the driving motor 1131 and the transmission rack 1132. The driving motor 1131 is fixed on one of the first main shell 111 and the first sliding shell 112, and the transmission rack 1132 is fixed on the other of the first main shell 111 and the second sliding shell 122. The length direction of the transmission rack 1132 is perpendicular to the length direction of the first main shell 111, and the output shaft of the driving motor 1131 is in transmission connection with the transmission rack 1132.

In the case that the first transmission mechanism 113 includes the transmission rack 1132, the stability of the first main housing 11 in the sliding rolling state can be ensured by the cooperation between the driving motor 1131 and the transmission rack 1132, and thus the flattening of the flexible display screen 3 can be ensured, so as to ensure the display effect of the display device.

The number of the transmission racks 1132 may be one or more. When the first transmission mechanism 113 includes a plurality of transmission racks 1132, the arrangement direction of the plurality of transmission racks 1132 is parallel to the length direction of the display device. In this way, the first sliding shell 112 may be caused to slide relative to the first main shell 111 at a plurality of positions, thereby ensuring the stability of the first main housing 11 when switching between the sliding rolling state and the retracting state.

For example, as shown in FIG. 6, the first transmission mechanism 113 includes two transmission racks 1132, that are the first transmission rack and the second transmission rack. In order to realize the synchronous transmission of the first transmission rack and the second transmission rack by the driving motor 1131, the driving motor 1131 is a double-shaft output motor. Accordingly, two output shafts of the driving motor 1131 are respectively in transmission connection with the first transmission rack and the second transmission rack. Alternatively, the first transmission mechanism 113 includes two driving motors 1131, that are the first driving motor and the second driving motor, where the first driving motor is in transmission connection with the first transmission rack, and the second driving motor is in transmission connection with the second transmission rack.

In the case that the driving motor 1131 is the double-shaft output motor, the synchronization of the movements of the first transmission rack and the second transmission rack can be well ensured. In the case that the first transmission mechanism 113 includes the first driving motor and the second driving motor, in order to ensure the synchronization of the movements of the first transmission rack and the second transmission rack, the first transmission rack and the second transmission rack are to be synchronously controlled by the same controller.

Optionally, as shown in FIG. 6, the first transmission mechanism 113 includes the transmission rod 1133, the driving motor 1131 is in transmission connection with the transmission rod 1133, and the transmission rod 1133 is in transmission connection with the transmission rack 1132.

The output shaft of the driving motor 1131 and the transmission rod 1133 are in transmission connection through a spur gear meshing or a bevel gear meshing. A spur gear is fixed on the transmission rod 1133, so that the transmission rod 1133 is in transmission connection with the transmission rack 1132 through the spur gear.

In the case that the output shaft of the driving motor 1131 is meshed with the transmission rod 1133 through the spur gear, the axial direction of the output shaft of the driving motor is parallel to the length direction of the transmission rod 1133. At this time, optionally, both the driving motor 1131 and the transmission rod 1133 may be arranged along the length direction of the display device, thereby reducing the space occupied by the whole transmission mechanism 113 inside the first main housing 11. In the case that the output shaft of the driving motor 1131 is meshed with the transmission rod 1133 through the bevel gear, the axial direction of the output shaft of the driving motor is perpendicular to the length direction of the transmission rod 1133. At this time, optionally, the driving motor 1131 is arranged along a direction perpendicular to the length direction of the display device, and the transmission rod 1133 is arranged along the length direction of the display device.

In the case that the first transmission mechanism 113 includes the transmission rod 1133, the number of transmission racks 1132 may be more than one, as long as a corresponding number of spur gears may be arranged on the transmission rod 1133, which is not limited in the embodiments of the present disclosure. In this way, through the arrangement of the transmission rod 1133, the distance between two adjacent transmission racks 1132 may be adjusted in the case of including a plurality of transmission racks 1132, so that the relative sliding between the first sliding shell 112 and the first main shell 111 can be realized in a larger area, and the stability when driving the first sliding shell 112 to slide can be ensured.

When the driving motor 1131 and the transmission rack 1132 are in transmission connection through the transmission rod 1133, in the case that the driving motor 1131 is the double-shaft output motor, as shown in FIG. 6, the first transmission mechanism 113 includes two transmission rods 1133, that are the first transmission rod and the second transmission rod. The two output shafts of the double-shaft output motor are in transmission connection with the first transmission rod and the second transmission rod respectively, the first transmission rod is in transmission connection with the first transmission rack, and the second transmission rod is in transmission connection with the second transmission rack.

Optionally, in the case that the first transmission mechanism 113 includes the transmission rack 1132, one of the first sliding shell 112 and the first main shell 111 is provided with the slide slot, and the transmission rack 1132 is fixed on the other of the first sliding shell 112 and the first main shell 111 and slidably limited in the slide slot.

In this way, the transmission rack 1132 is fixedly connected with one of the first sliding shell 112 and the first main shell 111, and is limited in the other of the first sliding shell 112 and the first main shell 111, thereby ensuring the stability of the first sliding shell 112 and the first main shell 111 when they slide relatively.

For example, the transmission rack 1132 is fixed in the housing of the first main shell 111, the inner shell wall of the first sliding shell 112 is provided with the slide slot, and the transmission rack 1132 is slidably limited in the slide slot.

For example, when the second main housing 12 has the sliding rolling state and the retracting state, as shown in FIG. 2 or FIG. 4. The second main housing 12 includes the second main shell 121 and the second sliding shell 122. The edge of the second main shell 121 along the length direction is connected with the folding mechanism 2, the second sliding shell 122 is connected at one side of the second main shell 121 away from the folding mechanism 2, and the second sliding shell 122 is slidable relative to the second main shell 121 along the direction perpendicular to the length direction.

With respect to the structures of the second sliding shell 122 and the second main shell 121, and the sliding of the second sliding shell 122 relative to the second main shell 121, the structures of the first sliding shell 112 and the first main shell 111 and the sliding of the first sliding shell 112 relative to the first main shell 111 described in the above embodiments can be referred to, which will not be elaborated in the present disclosure. For example, the shell wall of the second main shell 121 is provided with a plurality of first comb teeth structures 1111 facing the second sliding shell 122, and the shell wall of the second sliding shell 122 is provided with a plurality of second comb teeth structures 1125 facing the second main shell 121, and the plurality of first comb teeth structures 1111 are meshed with the plurality of second comb teeth structures 1125.

In addition, as shown in FIG. 5, the flexible display screen 3 includes not only the first display area 32, the second display area 33 and the folding zone 34, but also the second sliding rolling zone 36. The first display area 32 is limited on the first main shell 111, the second display area 33 is limited on the second main shell 121, and the second sliding rolling zone 36 is slidably fixed on the second sliding shell 122.

In this way, when the second sliding shell 122 moves along the direction away from the second main shell 121, the second sliding rolling zone 36 slides relative to the second sliding shell 122, so that the second sliding rolling zone 36 is in the flat form and is in the coplanar form with the second display area 33, thereby displaying images in the second sliding rolling zone 36, the first display area 32, the second display area 33 and the folding zone 34. When the second sliding shell 122 slides along the direction close to the second main shell 121, the second sliding rolling zone 36 slides relative to the second sliding shell 122, so that the second sliding rolling zone 36 is in the curled form, thereby displaying images in the first display area 32, the second display area 33 and the folding zone 34. In addition, when the second main housing 12 is switched between the sliding rolling state and the retracting state, the display device may be switched between two different screen ratios accordingly, thereby improving the display effect of the display device.

When the second sliding shell 122 electrically slides relative to the second main shell 121, as shown in FIG. 6, the second main housing 12 further includes the second transmission mechanism 123, which is connected with the second main shell 121 and the second sliding shell 122 respectively. With respect to the specific structure of the second transmission mechanism 123, the first transmission mechanism 113 described in the above embodiments can be referred to, which is not limited in the embodiments of this application.

Optionally, for the display device in which the first main housing 11 includes the first sliding shell 112 and the second main housing 12 includes the second sliding shell 122, the maximum slide stroke of the first sliding shell 112 is twice that of the second sliding shell 122. That is, the width of the first sliding rolling zone 35 of the flexible display screen 3 mentioned above is twice that of the second sliding rolling zone 36. Alternatively, the maximum slide stroke of the first sliding shell 112 can also be greater than twice the maximum slide stroke of the second sliding shell 122, which is not limited in the embodiments of the present disclosure.

Other embodiments of the present disclosure will easily occur to those skilled in the art after considering the description and practicing the present disclosure. The present application is intended to cover any variations, uses or adaptations of the present disclosure, which follow the general principles of the present disclosure and include common knowledge or common technical means in the art that are not disclosed in the present disclosure. The description and embodiments are to be regarded as exemplary only, with the true scope and spirit of the present disclosure being indicated by the following claims.

1. A display device, comprising:
a display housing, comprising a first main housing and a second main housing, wherein a width of the first main housing is greater than a width of the second main housing;
a folding mechanism, located between the first main housing and the second main housing, and respectively connected with an edge of the first main housing along a length direction and an edge of the second main housing along the length direction, wherein the first main housing and the second main housing are switchable between folding and unfolding; and
a flexible display screen, respectively connected with the first main housing and the second main housing, and provided with a binding area, wherein the binding area is located at one side of the first main housing in the length direction.

2. The display device according to claim 1, wherein the first main housing comprises a first main shell and a first sliding shell;
an edge of the first main shell along the length direction is connected with the folding mechanism, the first sliding shell is connected at one side of the first main shell away from the folding mechanism, and the first sliding shell is slidable relative to the first main shell along a direction perpendicular to the length direction; and
the flexible display screen is slidably fixed on the first sliding shell, and the binding area is located at a side of the first main shell in the length direction.

3. The display device according to claim 2, wherein a shell wall of the first main shell is provided with a plurality of first comb teeth structures facing the first sliding shell, a shell wall of the first sliding shell is provided with a plurality of second comb teeth structures facing the first main shell, and the plurality of first comb teeth structures are meshed with the plurality of second comb teeth structures.

4. The display device according to claim 3, wherein the first comb tooth structure and the second comb tooth structure are both rectangular.

5. The display device according to claim 2, wherein the first sliding shell comprises a first frame, a second frame, a side plate and a plurality of sliding rods; and
the first frame and the second frame are oppositely arranged, the side plate is connected between the first frame and the second frame, opposite side walls of the first frame and the second frame are provided with slideways, ends of the plurality of sliding rods are slidably limited in the slideways on the first frame and the second frame, and the flexible display screen is fixed on the plurality of sliding rods.

6. The display device according to claim 2, wherein the first main housing further comprises a first transmission mechanism comprising a driving motor and a transmission rack; and
the driving motor is fixed on one of the first main shell and the first sliding shell, the transmission rack is fixed on another one of the first main shell and the first sliding shell, a length direction of the transmission rack is perpendicular to the length direction of the first main shell, and an output shaft of the driving motor is in transmission connection with the transmission rack.

7. The display device according to claim 6, wherein the first transmission mechanism comprises a first transmission rack and a second transmission rack; and
the driving motor is a double-shaft output motor, and two output shafts of the driving motor are respectively in transmission connection with the first transmission rack and the second transmission rack;
or, the first transmission mechanism comprises a first driving motor and a second driving motor, wherein the first driving motor is in transmission connection with the first transmission rack, and the second driving motor is in transmission connection with the second transmission rack.

8. The display device according to claim 6, wherein the first transmission mechanism comprises a transmission rod, the driving motor is in transmission connection with the transmission rod, and the transmission rod is in transmission connection with the transmission rack.

9. The display device according to claim 6, wherein one of the first sliding shell and the first main shell is provided with a slide slot, and the transmission rack is fixed on another one of the first sliding shell and the first main shell and slidably limited in the slide slot.

10. The display device according to claim 1, wherein the second main housing comprises a second main shell and a second sliding shell; and
an edge of the second main shell along the length direction is connected with the folding mechanism, the second sliding shell is connected at one side of the second main shell away from the folding mechanism, and the second sliding shell is slidable relative to the second main shell along a direction perpendicular to the length direction.

11. The display device according to claim 1, wherein the width of the first main housing is twice the width of the second main housing.

12. The display device according to claim 1, a maximum slide stroke of the first sliding shell is twice a maximum slide stroke of the second sliding shell.

13. The display device according to claim 3, wherein the first main housing further comprises a first transmission mechanism comprising a driving motor and a transmission rack; and
the driving motor is fixed on one of the first main shell and the first sliding shell, the transmission rack is fixed on another one of the first main shell and the first sliding shell, a length direction of the transmission rack is perpendicular to the length direction of the first main shell, and an output shaft of the driving motor is in transmission connection with the transmission rack.

14. The display device according to claim 4, wherein the first main housing further comprises a first transmission mechanism comprising a driving motor and a transmission rack; and
the driving motor is fixed on one of the first main shell and the first sliding shell, the transmission rack is fixed on another one of the first main shell and the first sliding shell, a length direction of the transmission rack is perpendicular to the length direction of the first main shell, and an output shaft of the driving motor is in transmission connection with the transmission rack.

15. The display device according to claim 5, wherein the first main housing further comprises a first transmission mechanism comprising a driving motor and a transmission rack; and
the driving motor is fixed on one of the first main shell and the first sliding shell, the transmission rack is fixed on another one of the first main shell and the first sliding shell, a length direction of the transmission rack is perpendicular to the length direction of the first main shell, and an output shaft of the driving motor is in transmission connection with the transmission rack.

16. The display device according to claim 2, wherein the second main housing comprises a second main shell and a second sliding shell; and
an edge of the second main shell along the length direction is connected with the folding mechanism, the second sliding shell is connected at one side of the second main shell away from the folding mechanism, and the second sliding shell is slidable relative to the second main shell along a direction perpendicular to the length direction.

17. The display device according to claim 3, wherein the second main housing comprises a second main shell and a second sliding shell; and
an edge of the second main shell along the length direction is connected with the folding mechanism, the second sliding shell is connected at one side of the second main shell away from the folding mechanism, and the second sliding shell is slidable relative to the second main shell along a direction perpendicular to the length direction.

18. The display device according to claim 4, wherein the second main housing comprises a second main shell and a second sliding shell; and
an edge of the second main shell along the length direction is connected with the folding mechanism, the second sliding shell is connected at one side of the second main shell away from the folding mechanism, and the second sliding shell is slidable relative to the second main shell along a direction perpendicular to the length direction.

19. The display device according to claim 5, wherein the second main housing comprises a second main shell and a second sliding shell; and
an edge of the second main shell along the length direction is connected with the folding mechanism, the second sliding shell is connected at one side of the second main shell away from the folding mechanism, and the second sliding shell is slidable relative to the second main shell along a direction perpendicular to the length direction.

20. The display device according to claim 2, wherein the width of the first main housing is twice the width of the second main housing.
